(19) United States
(12) Patent Application Publication
(10) Pub. No.: US 2013/0181064 A1
(43) Pub. Date: Jul. 18, 2013

(54) THERMAL FOGGING DEVICE USING A LIQUID AND RELATED METHOD

(71) Applicants: Stefano Sardo, Chateaurenard (FR); Alberto Sardo, Chateaurenard (FR)

(72) Inventors: Stefano Sardo, Chateaurenard (FR); Alberto Sardo, Chateaurenard (FR)

(73) Assignee: XEDA INTERNATIONAL, Saint Andiol (FR)

(21) Appl. No.: 13/825,333

(22) PCT Filed: Sep. 14, 2011
(86) PCT No.: PCT/FR2011/052097

§ 371 Date: Mar. 21, 2013

(30) Foreign Application Priority Data
Sep. 22, 2010 (FR) 1057624

(51) Int. Cl. A23B 7/144; B05B 7/30; B05B 7/22

(52) U.S. Cl. CPC A23B 7/144; B05B 7/22; B05B 7/30
USPC 239/69; 239/75; 239/135; 239/307; 239/340

(57) ABSTRACT

The thermal fogging device using a liquid, comprises:
an assembly (3) for producing a pressurised hot gas flow;
an ejection pipe (5);
a first liquid source (7);
the means (9) for injecting into the ejection pipe (5) a metered liquid flow from the first liquid source (7),
   characterised in that the means (9) for injecting the metered liquid flow comprises a Venturi device (V) having an area (R), the cross-section of which is narrowed so as to enable the suction of the metered liquid flow.

The invention relates in general to a thermal fogging device using liquids, and in particular to the thermal fogging process using liquid compositions for treatment of fruits and vegetables.

More precisely, the invention relates according to a first aspect, to a device for thermal fogging using a liquid, comprising:

an assembly for producing a pressurised hot gas flow, having in particular a hot gas outlet,

an ejection pipe, having in particular a hot gas inlet connected to the hot gas outlet of the production assembly, and an ejection outlet for a liquid spray mist;

a first liquid source,

the means for injecting into the ejection pipe a metered liquid flow from the first liquid source.

Such a device is known from FR 2 566 681, which discloses that the liquid is injected into the ejection pipe by a pump extracting said liquid in a tank. The stream of gas is constituted by air, heated by an electrical resistor.

Such a device however, presents several problems that are detrimental to the proper operation of the device and to the efficacy of the thermal fogging. The wear and tear on the gears of the pump or any eventual variations in the electric voltage supplied to the pump may for example cause fluctuations in the flow of liquid suctioned. These differences in flow disrupt the proper operation of the thermal fogging device, and can even cause fire hazards. In addition, the pump generally has a poor resistance to the organic solvents used for the purpose of spraying on fruits and/or vegetables, these solvents being liable in particular to attack the plastic gears of the pump, especially the joints. Finally, the use of a pump makes it necessary to determine a specific point of injection of the liquid into the flow of pressurised hot gas, which does not allow for obtaining an optimal dispersion of the liquid in such a hot gas flow.

In this context, the invention aims to increase the reliability and efficiency of a thermal fogging device of the aforementioned type, in order to overcome the disadvantages mentioned above.

To this end, the invention relates to a device for thermal fogging of the aforementioned type, characterised in that the means for injecting the metered flow of liquid comprise a venturi device having an area, the cross-section of which is narrowed so as to enable the suction of the metered liquid flow.

The device may also have one or more of the following characteristic features, considered individually or according to all technically possible combinations :

the venturi device includes a convergent section upstream of the narrow cross section area and a divergent section downstream from the narrow cross section area, when considering the direction of flow of the stream of hot gas in the ejection pipe;

the diameter of the ejection pipe upstream of the venturi device is between 12 mm and 25 mm, preferably between 15 mm and 20 mm, and even more preferably between 16 mm and 18 mm, and such that the diameter of the narrow cross section area of the venturi device is between 1 mm and 20 mm;

the assembly for producing a pressurised hot gas flow comprises a blower, provided with a gas suction inlet and a pressurised gas discharge outlet, and a heating device for the pressurised gas, having a cold gas inlet connected to the discharge outlet of the blower, and an outlet constituting the hot gas outlet;

the flow rate of the blower varies between 20 Nm³/h and 100 Nm³/h, preferably between 40 Nm³/h and 70 Nm³/h, for example being equal to 60 Nm³/h;

the blower has a pressure difference between discharge and suction of between 0.1 10⁵ Pa and 1 10⁵ Pa, preferably between 0.2 10⁵ Pa and 0.5 10⁵ Pa;

the heating device heats the gas stream at a temperature between 400 and 700° C., preferably between 450 and 650° C., preferably between 500 and 600° C., at the entrance of the ejection pipe;

the means for supplying the metered liquid flow to the ejection pipe comprise a suction pipe, a valve, and an extraction pipe, the suction pipe connecting a first outlet of the valve to a liquid inlet opening into the narrow cross section area of the venturi device and the extraction pipe connecting a second outlet of the valve to the first liquid source;

the ejection pipe includes a flared portion downstream from the venturi device, the flared portion having a divergent section;

the device comprises a sensor probe for detecting a total or partial interruption of the flow of metered liquid injected into the ejection pipe from the first liquid source;

the device comprises a second liquid source;
the device includes the means for injecting into the ejection pipe an emergency flow of liquid from the second liquid source when the sensor probe detects a total or partial interruption of the flow of metered liquid injected into the ejection pipe from the first liquid source, the means comprising a valve member, in particular an on-off valve, capable of selectively connecting the liquid suction inlet of the venturi device to the second liquid source;
the sensor probe is a temperature sensor probe suitable for measuring the current temperature of the gas in the ejection pipe downstream from the liquid inlet and such that the device comprises a computer suitable for collecting the current temperature of the gas measured by the sensor probe, and able to compare this current temperature with a predetermined maximum value, and to automatically command the valve member to at least partially close when the temperature measured by the sensor probe is lower than the predetermined temperature, and to open at least partially when the temperature measured by the sensor probe is higher than the predetermined temperature; and

the second liquid source is a water tank substantially sealed to be air tight, the means for injecting into the ejection pipe an emergency flow of liquid from the second liquid source comprising a pressurised pipe connecting the discharge outlet of the blower to a second crown of the liquid source and an injection pipe connecting the second liquid source to a liquid inlet opening into the venturi device of the ejection pipe.

According to a second aspect, the invention relates to a method of thermal fogging using a liquid, implemented in particular by means of the device previously described above, said method comprising of the following steps :

creating a current of pressurised hot gas,

injecting a metered flow of liquid into the current of pressurised hot gas by suction of the liquid by means of a venturi device.

Additional characteristic features and advantages of the invention will become apparent from the description given here below for purely indicative purposes and in no way limiting, with reference to the accompanying drawings, in which:

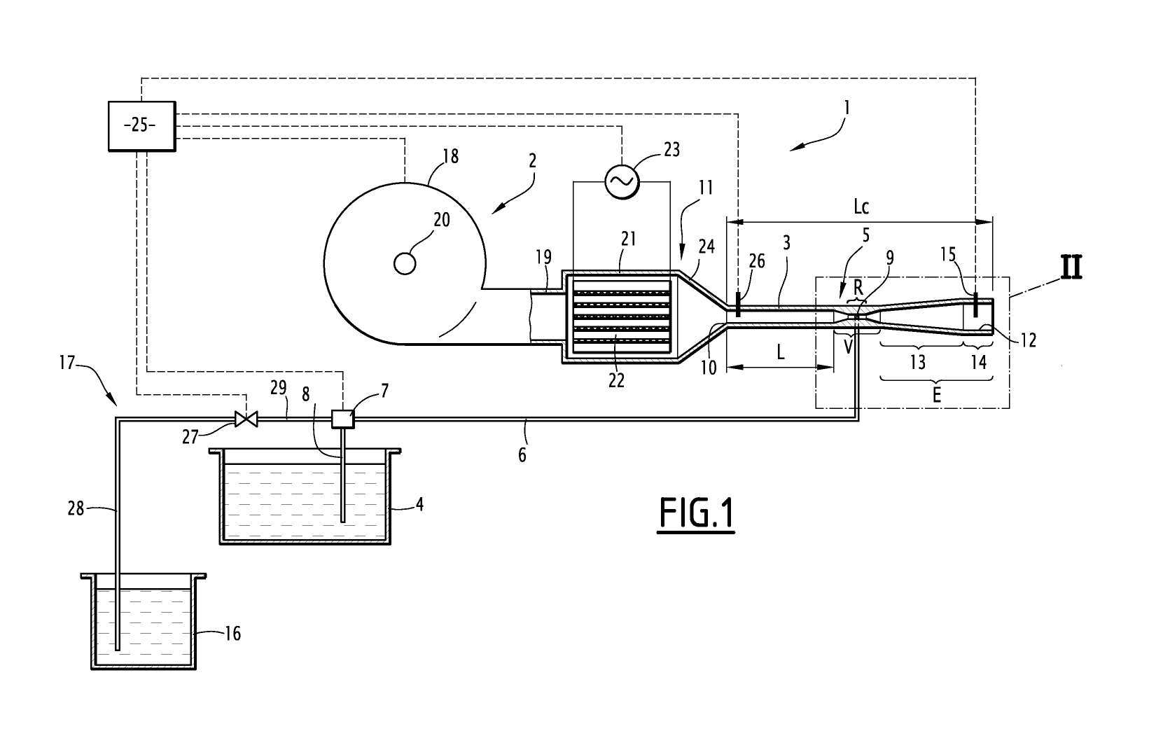

FIG. 1 is a simplified schematic representation of a thermal fogging device according to a first embodiment of the invention,

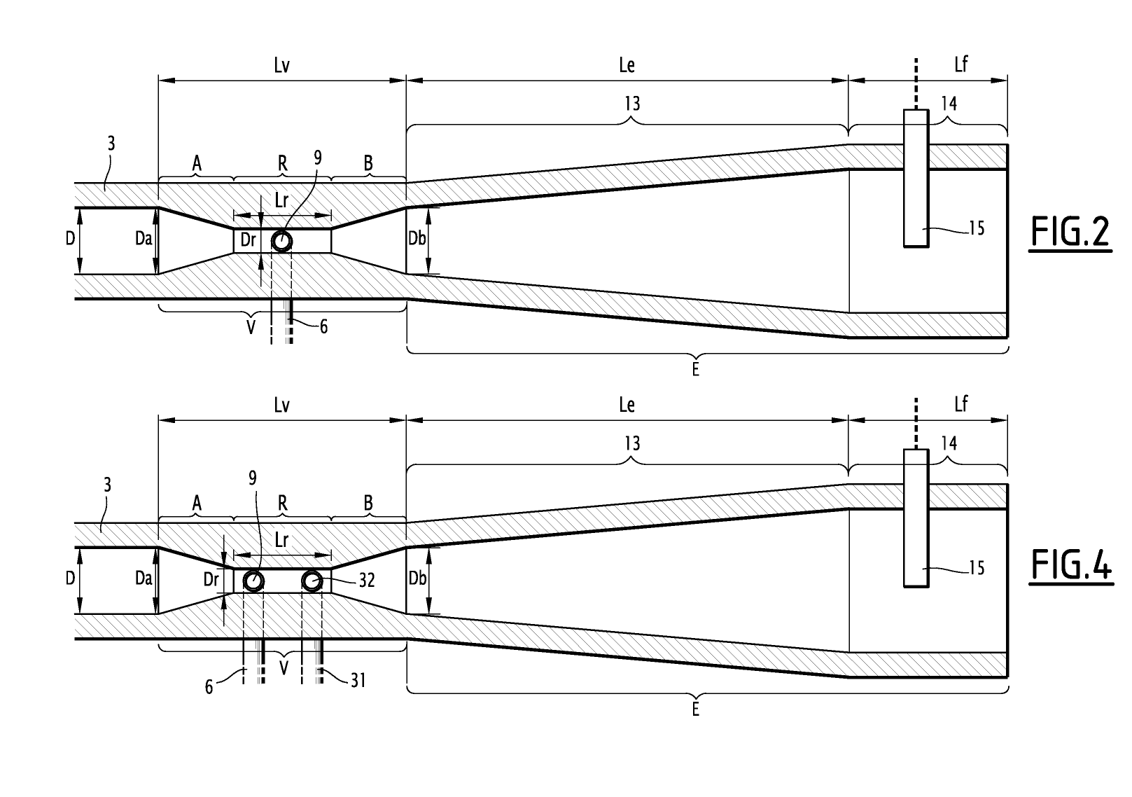

FIG. 2 is an enlarged view of the zone II in FIG. 1,

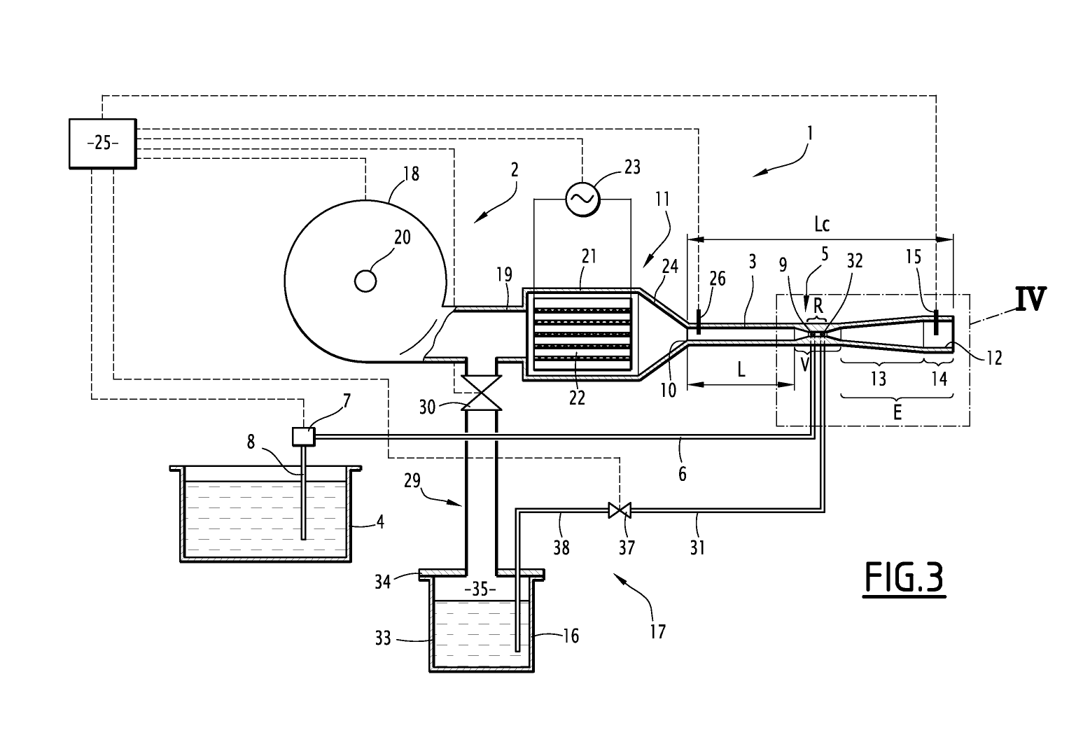

FIG. 3 is a view similar to that of FIG. 1, for a second embodiment of the invention,

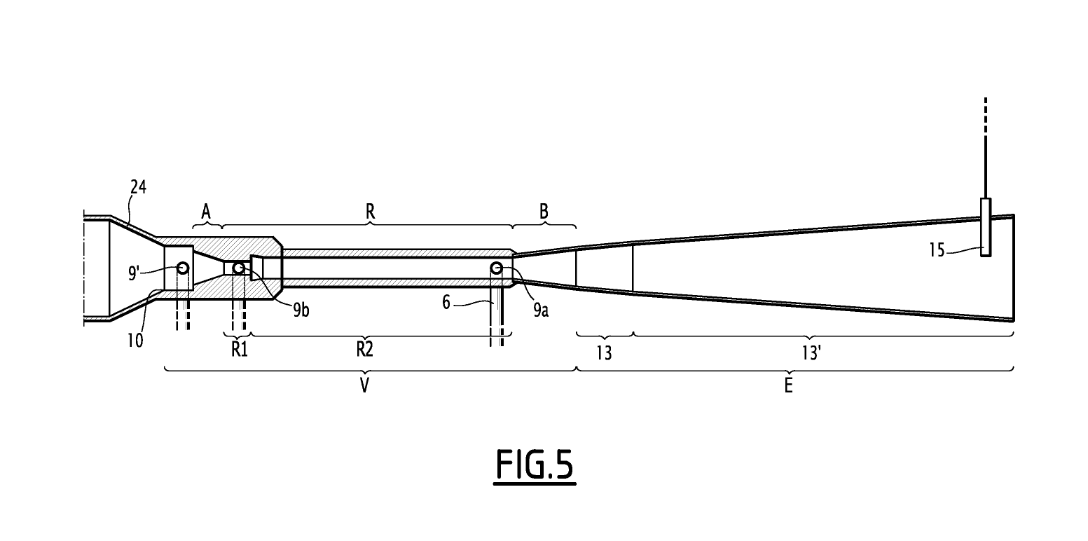

FIG. 4 is an enlarged view of the zone IV in FIG. 3, and

FIG. 5 is a schematic representation of an alternative embodiment of a thermal fogging device according to the invention.

The device shown in FIG. 1 is a thermal fogging device designed to produce a gas flow consisting of a liquid spray mist. The liquid spray mist comprises of very fine droplets at least 90% of the droplets preferably having a diameter that is less than or equal to 3 microns.

Such a device is typically provided for the treatment of fruit and vegetables stored in enclosed facilities, in particular greenhouses or storage enclosures.

The liquid constituting the spray mist is typically an aqueous solution containing a chemical agent suitable for the treatment of fruits and vegetables. This chemical agent has for example a protective activity intended to extend the shelf life of fruits and vegetables. It may have an antioxidant effect, a germicidal effect and/or fungicidal effect. Such compositions are described in patent applications FR 2 728 142, FR 2 786 664 and FR 2 791 910.

The thermal fogging device 1 comprises:

an assembly 2 for producing a pressurised hot gas flow

an ejection pipe 3

a first source 4 of a liquid containing a chemical treatment agent,

the means 5 for supplying to the ejection pipe a metered liquid flow from the first liquid source 4.

The means 5 for supplying to the ejection pipe a metered liquid flow comprises a venturi device V which has an area with a narrowed cross-section R so as to enable the suction of the metered liquid flow. The means 5 further comprise a suction pipe 6, a valve member 7, in particular a three way valve, and an extraction pipe 8. The suction pipe 6 connects a first outlet of the valve 7 to a liquid inlet 9 opening into the narrow cross section R area of the venturi device V. In addition, the extraction pipe 8 connects a second outlet of the valve 7 to the tank 4.

As can be seen more clearly in FIG. 2, the venturi device V includes a convergent section A upstream of the narrow cross section R area and a divergent section B downstream from the narrow cross section R area. By way of a variant, the venturi device V does not have a divergent section B. The terms “upstream” and “downstream” are to be understood relative to the direction of flow of the hot gas flow in the ejection pipe 3, going from left to right in FIG. 1.

The venturi device V is advantageously housed in the ejection pipe 3. In this particular example, the venturi device V is formed by modification of the thickness of the wall of the ejection pipe 3, in a manner so as to form the convergent section A, the narrow cross section R area and the divergent section B. By way of a variant, the wall of the ejection pipe 3 has a constant uniform thickness.

The diameter D of the ejection pipe 3 upstream of the venturi device V is for example between 12 mm and 25 mm, preferably between 15 mm and 20 mm, and even more preferably between 16 mm and 18 mm.

The diameter Da of the venturi device V at the inlet of the convergent section A is for example between 12 mm and 25 mm, preferably between 15 mm and 20 mm, and even more preferably between 16 mm and 18 mm.

The diameter Db of the venturi device V at the outlet B of the divergent section is for example between 12 mm and 25 mm, preferably between 15 mm and 20 mm, and even more preferably between 16 mm and 18 mm.

The diameters D, Da and Db may have values that are all the same or all different. By way of a variant, only two of these may have identical values, the third having a different value.

The length Lc of the ejection pipe 3 is for example between 200 mm and 2500 mm, for example between 200 mm and 1500 mm. The length Lv of the venturi device V is for example between 100 mm and 500 mm. The length L of the ejection pipe 3 upstream of the venturi device V is for example less than 500 mm, for example between 100 mm and 500 mm.

The diameter Dr of the narrow cross section R area of the venturi device V is for example between 1 mm and 20 mm, and the length Lr of the narrow cross section R area is for example between 5 mm and 100 mm.

The ejection pipe 3 is a substantially cylindrical pipe. It is open at its two ends. One of the ends defines a hot gas inlet connected to the outlet 10 of the heating device 11 described hereinafter. The opposite end defines an ejection outlet 12 for a hot gas flow loaded with a liquid spray mist.

The rate of injection of liquid coming from the first liquid source 4 to the inlet 9 of the ejection pipe 3 is generally between 5 and 100 litres per hour, preferably between 10 and 30 litres per hour, and even more preferably between 13 and 20 litres per hour. The temperature of the liquid injected into the pipe 3 is generally between 0° C. and 50° C., preferably between 10° C. and 25° C., and more preferably between 20° C. and 25° C.

The ejection pipe 3 also comprises a flared portion E downstream from the venturi device V. The flared portion E includes for example a divergent section 13 and a straight section 14. By way of a variant, the flared portion E does not have a straight portion 14, as it can be seen in FIG. 5.

The diameter De at the outlet of the divergent section 13 is for example between 15 mm and 250 mm. The length of the divergent section 13 is for example between 250 mm and 2000 mm. The length Lf of the straight section 14 is for example less than 1000 mm, for example between 100 mm and 1000 mm, for example being equal to about 150 mm.

The thermal fogging device 1 also includes the component elements of a security system of the type such as described in patent application FR 2 938 458, namely:

a sensor probe 15 for detecting a total or partial interruption of the flow of metered liquid arriving from the first liquid source 4;

a second liquid source 16;

the means 17 for supplying to the ejection pipe 3 an emergency flow of liquid from the second liquid source 16 when the sensor probe 15 detects a total or partial interruption of the flow of metered liquid arriving from the first liquid source 4.

The production assembly 2 comprises a blower 18 and a heating device 11. The blower 18 has an inlet for suction of atmospheric air (not shown) and an outlet 19 for discharge of pressurised air. The shaft 20 of the blower 18 is driven by an electric motor that is not shown.

The heating device 11 includes a casing 21, a heating resistor 22 and an electric generator 23 electrically connected to the resistor 22. The resistor 22 is located inside the casing 21. The casing 21 has a cold gas inlet connected to the discharge outlet 19 of the blower, and a converging section 24 defining an outlet for pressurised hot gas 10. The electric generator 23 may form a single block with the blower 18, thus constituting the ground portion of the thermal fogging device 1.

The first liquid source 4 is typically a tank filled with the treatment liquid. This liquid is typically a solution of a chemical treatment agent, in water, an organic solvent or a pure essential oil.

The sensor probe 15 is placed in the ejection pipe 3, downstream from the liquid inlet 9. It is preferably placed close to the ejection outlet 12, for example in the straight portion 14 of the flared portion E. It provides information to a computer 25.

The sensor probe 15 is a temperature sensor probe that measures the temperature of the liquid spray mist at the ejection outlet 12. The valve 7 is controlled automatically by the computer 25 so as to be at least partially closed when the temperature measured by the sensor probe 15 is lower than a predetermined desired temperature, in order to reduce the flow rate of liquid being suctioned from the tank 4 and to increase the temperature of the liquid spray mist at the ejection outlet 12.

In a similar fashion, the valve 7 is controlled automatically by the computer 25 so as to be at least partially open when the temperature of the sensor probe 15 is greater than the predetermined desired temperature, in order to increase the flow rate of the liquid being suctioned from the tank 4 and to reduce the temperature of the liquid spray mist at the ejection outlet 12.

A temperature sensor probe 26 is also positioned in the proximity of the pressurised hot gas outlet 10, in order to control the temperature at the outlet of the electrical resistor 22.

The second liquid source 16 is for example a tank filled with water. This water does not have a chemical treatment agent.

The means 17 for supplying to the liquid inlet 9 an emergency flow of liquid from the second liquid source 16 comprises a solenoid valve 27, which may advantageously be replaced by two valves that close and open alternately, a suction pipe 28 connected to the second liquid source 16, and a connecting portion 29 connected to a third outlet of the three way valve 7 of the means 5 for supplying to the ejection pipe a metered flow of liquid. The solenoid valve 27 is interposed between the suction pipe 28 and the connecting portion 29.

The computer 25 is connected to the temperature sensor probes 15 and 26, to the electrical generator 23, to the motor of the blower 18 and to the valves 7 and 27. The computer 25 is capable of controlling each of these elements or to receive information from them.

The blower 18 has a pressure difference between discharge and suction of between 0.1 10⁵ Pa and 1 10⁵ Pa, preferably between 0.2 10⁵ Pa and 0.5 10⁵ Pa. The flow rate of the blower varies between 20 Nm³/h and 100 Nm³/h, preferably between 40 Nm³/h and 70 Nm³/h, for example being equal to 60 Nm³/h. Thus, the linear velocity of the hot air at the inlet of the ejection pipe 5 is between 160 m/s and 400 m/s, preferably between 200 m/s and 280 m/s. The electrical resistor 22 is appropriately dimensioned so as to be capable of heating the air to a temperature of between 400° C. and 700° C. at the inlet of the ejection pipe 3. Preferably, the electrical resistor 22 is dimensioned for heating the air to a temperature between 450° C. and 650° C., and even more preferably between 500° C. and 600° C. The electrical power of the resistor is between 2 kW and 20 kW, and preferably has a value of between 7.5 kW and 15 kW.

At the ejection outlet of the pipe 3, the liquid spray mist comprises droplets having a temperature of between 170° C. and 240° C., driven at a linear velocity of between 110 m/s and 140 m/s. To satisfy these conditions, the following criteria, in addition to the parameters described above, may be suitably adapted :

the dimensions with respect to the lengths of the pipe elements 3 :

the dimensions with respect to the diameter of the pipe elements 3 :

flow rate and temperature of the liquid suctioned at the inlet 9 of the pipe 3.

In one embodiment, the blower 18 provides a pressure difference between the suction and discharge amounting to 25,000 Pascal, and a flow rate of 60 Nm³/h. The pipe 3 has, upstream of the venturi device V a diameter D of 18 mm and a length Lc of 800 mm. The electrical resistor 22 has an electrical power of 10 kW. The temperature of the hot air at the inlet of the pipe 3 is about 600° C. The linear velocity of the hot air at the inlet of the pipe 3 is approximately 220 m/s. Liquid is suctioned at the inlet 9 of the pipe 3 at a flow rate of 15 litres per hour and at a temperature of 20° C. to 25° C. At the ejection outlet 12 of the pipe a spray mist of droplets having an average diameter of 0.4 microns is obtained. The linear velocity of the droplets at the outlet of the pipe 3 is 125 m/s and the temperature of the droplets is approximately between about 170° C. to 240° C., depending on the product.

The operation of the thermal fogging device 1 here above shall now be described.

At startup, the computer 25 sends a command to the valve 7 to isolate the connecting portion 29 and to connect the suction pipe 6 and the extraction pipe 8. The computer 25 controls the startup of the blower 18 and the power supply for the resistor 22. The blower 18 suctions the atmospheric air and blows it through the heating device 11 up to the pipe 3. The venturi device V suctions the treatment solution in the tank 4 by means of the suction pipe 6 under the effect of the reduction of the outflow velocity of the hot gas flow in the narrow cross section R area of the venturi device V. The liquid from the tank 4 suctioned by the venturi device V is injected into the hot gas flow at over 600° C. from the heating device. The liquid is dispersed in the hot gas flow and broken into very fine droplets. A part of the liquid is eventually vaporised. Under the effect of the injection of liquid, the gas flow is cooled, its temperature going from about 625° C. to about 170° C.-240° C.

The computer 25 continuously monitors the temperature of the gas flow loaded with liquid spray mist downstream from the inlet 9, at the ejection outlet 12, by means of the sensor probe 15. The computer 25 automatically controls the at least partial opening and closing of the valve 7 in the event, respectively, of the temperature measured by the sensor probe 15 exceeding or dropping below the level with respect to a predetermined desired temperature.

Moreover, if the liquid flow arriving from the tank 4 is interrupted completely or partially, the temperature measured by the sensor probe 15 increases. This interruption results for example due to the fact that the tank 4 is empty, all the liquid having already been injected into the pipe 3. This interruption may also result from the fact that the extraction pipe 8 is blocked, whether completely or partially. On account of the liquid being injected in lower quantities, or not at all being injected into the pipe 3, the gas flow is no longer being cooled in the same manner, and the temperature of the gas flow increases at the sensor probe 15. When the computer 25 detects that the temperature measured by the sensor probe 15 exceeds a maximum target value, for example 400° C., the computer 25 sends a command to the three way valve 7 to isolate the extraction pipe 8 and sends a command to the solenoid valve 27 to connect the connecting portion 29 with the suction pipe 28.

Thus, the venturi device V suctions the water contained in the second liquid source 16, causing a sharp drop in temperature due to the evaporation.

The resumption of the injection of liquid into the pipe 3 leads to the reestablishment of steady state conditions and the gases are again brought to a temperature of about 170° C.-240° C.

A second embodiment of the invention shall now be described with reference to FIGS. 3 and 4. Only the points where the second embodiment differs from the first are detailed here below.

Elements that are identical, or performing the same function, are designated by the same reference numerals in both embodiments.

The means 17 of supplying an emergency flow of liquid to the ejection pipe 3 from the second liquid source 16 comprise in the second embodiment, a pressurising pipe 29 for the tank 16, a solenoid valve 30 interposed in the pipe 29, a connecting pipe 38 connecting the tank 16 to a valve member 37, and an injection pipe 31 connecting the valve member 37 to a second liquid inlet 32 of the ejection pipe 3.

The pipe 29 connects the discharge of the blower 18 to the crown of the tank 16. Thus, an upstream end of the pipe 29 is connected to the discharge outlet 19 of the blower. The downstream end of the pipe 29 opens into the crown of the tank 16.

The solenoid valve 30 is an on-off valve, controlled by the computer 25. It can allow or prevent the circulation of air from the discharge of the blower to the crown of the tank 16.

In this second embodiment, the tank 16 is airtight tank. It comprises for example a vat 33 open at the top, and a cover 34 for closing the vat 33. Sealing means are provided between the cover and the vat, provided in order to prevent air leakage when the tank 16 is maintained at a pressure at least equal to the discharge pressure of the blower 18. The pipe 29 is attached on to the cover 34. For example, the end of the pipe 29 is welded to the cover 34.

An upstream end of the connecting pipe 38 passes through the cover 34 and is immersed in the water contained in the tank 16. A seal is formed between the pipe 38 and the cover 34. This seal is produced, for example by welding of the pipe 38 on the cover 34. Alternatively, a sealing gasket is interposed between the pipe 38 and the cover 34.

The tank 16 is partially filled with water, the upper part 35 of the tank, also known as the crown, being normally filled with air.

The second liquid inlet 32 opens into the narrow cross section R area of the venturi device V, close to the first inlet 9, the narrow cross section area R enabling the suction of the flow of metered liquid coming from the tank 16.

The operation of the thermal fogging device 1 according to the second embodiment of the invention will now be described.

The startup is similar to that of the device according to the first embodiment of the invention, with the exception being that the computer 25 actuates the solenoid valve 30 to close the pressurising pipe 29 and at the valve 37 to close off the connecting pipe 38. The valves 30 and 37 are kept closed during normal operation of the fogging device, that is to say, as long as the computer 25 does not detect that the temperature measured by the sensor probe 15 exceeds the predetermined maximum value.

However, when the computer 25 instead detects that the temperature measured by the sensor probe 15 exceeds said maximum value, it actuates the opening of the solenoid valve 30 and the opening of the valve 37.

The crown 35 of the tank 16 is then connected with the discharge of the blower 18. Consequently, the liquid contained is pressurised, since the pressure that then prevails in the crown 35 corresponds to the discharge pressure of the blower 18.

The water contained in the tank 16 is forced by the pressure to the connecting pipe 38 and the injection pipe 31. This water is injected into the pipe 3 through the second liquid inlet 32.

It should be noted that the air pressure inside the ejection pipe 3 is lower than the air pressure at the discharge outlet 19 of the blower, due to the pressure loss that occurs in the heating device. Thus, the pressure in the crown of the tank 16 is higher than the pressure inside the ejection pipe 3. The passage section of the connecting pipe 38, and possibly that of the injection pipe 31, is dimensioned such that this difference in pressure allows sufficient outflow of liquid so as to cool the flow of hot gas entering the pipe 3.

In the event the temperature measured by the sensor probe 15 exceeds a predetermined maximum temperature, the computer may also actuate the opening of the valve 37, while maintaining the solenoid valve 30 closed, the liquid being then suctioned from the tank 16 through the pipes 38 and 31 by means of the venturi effect, so as to reduce the temperature at the ejection outlet 12.

A variant of the embodiment of a thermal fogging device according to the invention shall now be described with reference to FIG. 5. Only the points wherein this embodiment differs from the first and second embodiments are detailed here below.

Elements that are identical, or performing the same function, are designated by the same reference numerals.

The Venturi device V includes an area of narrowed cross section R which at the outlet has a liquid inlet 9a to which is connected the suction pipe 6 for the liquid coming from the tank 4.

The narrow cross section area R is formed of two parts R1 and R2, the part R1 being located upstream of the part R2 and having a smaller diameter than the part R2. A liquid inlet 9b is provided in the ejection pipe 3 to open in the narrow cross section area R at the level of its part R1. The liquid inlet 9b is, as necessary, connected to a pipe for suction of the liquid from the tank 4 or the liquid from the second liquid source 16.

The part of the ejection pipe 3 situated upstream of the venturi device V comprises a liquid inlet 9′. The liquid inlet 9′ makes it possible for example to connect a liquid inlet pipe, coming for example from the tank 4, the liquid being injected, for example by means of a pump.

The flared portion E comprises a first divergent section 13 and a second divergent section 13′, situated downstream from the first divergent section 13, the temperature sensor probe 15 being placed at the outlet of the second divergent section 13′.

The thermal fogging device 1 described here above has many advantages.

Due to the use of the venturi effect in order to suction the liquid and inject it into the ejection pipe 3, the thermal fogging device 1 according to the invention does not require the use of a liquid dosing member, in particular a pump, as taught by the prior art. The invention therefore makes it possible to avoid the problems of fluctuations in the flow of the injected liquid, to increase the reliability of the device and reduce the costs of design and maintenance. In addition, the suction of the liquid by Venturi effect allows for obtaining optimal homogenisation of the liquid suctioned into the hot gas flow, thereby augmenting the quality of the liquid spray mist obtained at the outlet of the ejection pipe 3.

The flared portion E which has a divergent section 13 with diameter De at the upper outlet having diameter Db at the outlet of the divergent section B of the venturi device V, advantageously enables the reduction of velocity of the fluid exiting from the venture device V. Thus, the larger sized droplets of the liquid spray mist that are undesirable for the thermal fogging treatment, may drop away under the force of gravity at the outlet 12 of the ejection pipe 3.

The thermal fogging device may have multiple variants, in particular such as those described in patent application FR 2 938 458.

1. Device for hot fogging using a liquid, the device comprising:
an assembly for producing a pressurised hot gas flow, having in particular a hot gas outlet,
an ejection pipe having a hot gas inlet connected to the hot gas outlet of the production assembly and an ejection outlet for a liquid spray mist,
a first liquid source,
the means for injecting into the ejection pipe a metered liquid flow from the first liquid source,
characterised in that the means for injecting the metered flow of liquid comprise a venturi device having a narrow cross section area so as to enable the suction of the metered liquid flow.

2. Device according to claim 1, characterised in that the venturi device includes a convergent section upstream of the narrow cross section area and a divergent section downstream from the narrow cross section area, when considering the direction of flow of the stream of hot gas in the ejection pipe.

3. Device according to claim 1, characterised in that the diameter of the ejection pipe upstream of the venturi device is between mm and 25 mm, preferably between 15 mm and 20 mm, and even more preferably between 16 mm and 18 mm, and in that the diameter of the narrow cross section area of the venturi device is between 1 mm and 20 mm.

4. Device according to claim 1, characterised in that:
the assembly for producing a pressurised hot gas flow comprises a blower provided with a gas suction inlet and a pressurised gas discharge outlet and a heating device for the pressurised gas, having a cold gas inlet connected to the discharge outlet of the blower, and an outlet constituting the hot gas outlet,
the flow rate of the blower varies between 20 Nm³/h and 100 Nm³/h, preferably between 40 Nm³/h and 70 Nm³/h, for example being equal to 60 Nm³/h,
the blower has a pressure difference between discharge and suction of between 0.1 10⁵ Pa and 1 10⁵ Pa, preferably between 0.2 10⁵ Pa and 0.5 10⁵ Pa, and
the heating device heats the gas stream at a temperature between 400 and 700° C., preferably between 450 and 650° C., preferably between 500 and 600° C., at the entrance of the ejection pipe.

5. Device according to claim 1, characterised in that the means for supplying the metered liquid flow to the ejection pipe comprise a suction pipe, a valve, and an extraction pipe, the suction pipe connecting a first outlet of the valve to a liquid inlet opening into the narrow cross section area of the venturi device and the extraction pipe connecting a second outlet of the valve to the first liquid source, the thermal fogging device comprising in addition one temperature sensor probe suitable for measuring the current temperature of the gases in the ejection pipe and a computer suitable for collecting the current temperature of the gas measured by the sensor probe and automatically controlling the opening or closing at least partially of the valve respectively in the event of the temperature measured by the sensor probe exceeding or dropping below the level with respect to a predetermined desired temperature.

6. Device according to claim 1, characterised in that the ejection pipe has a flared portion downstream from the venturi device, the flared portion includes a divergent section, the narrow cross section area of the venturi device having a diameter of between 1 mm and 20 mm, the divergent section having an outlet diameter of between 15 mm and 250 mm.

7. Device according to claim 1, characterised in that it further comprises:
a sensor probe for detecting a total or partial interruption of the flow of metered liquid injected into the ejection pipe from the first liquid source,
a second liquid source,
the means for injecting into the ejection pipe an emergency flow of liquid from the second liquid source when the sensor probe detects a total or partial interruption of the flow of metered liquid injected into the ejection pipe from the first liquid source, the means comprising a valve member, in particular an on-off valve, capable of selectively connecting the liquid suction inlet of the venturi device to the second liquid source.

8. Device according to claim 7, characterised in that the sensor probe is a temperature sensor probe suitable for measuring the current temperature of the gas in the ejection pipe downstream from the liquid inlet and in that the device comprises a computer suitable for collecting the current temperature of the gas measured by the sensor probe, and able to compare this current temperature with a predetermined maximum value, and to automatically command the valve member to at least partially close when the temperature measured by the sensor probe is lower than the predetermined temperature, and to open at least partially when the temperature measured by the sensor probe is higher than the predetermined temperature.

9. Device according to claim 7, characterised in that the second liquid source is a water tank substantially sealed to be air tight, the means for injecting into the ejection pipe an emergency flow of liquid from the second liquid comprising a pressurised pipe connecting the discharge outlet of the blower to a crown of the second liquid source and an injection pipe connecting the second liquid source to a liquid inlet opening into the venturi device of the ejection pipe.

10. Method of thermal fogging using a liquid, said method comprising the following steps:
creating a current of pressurised hot gas,
injecting a metered flow of liquid into the current of pressurised hot gas by suction of the liquid by means of a venturi device.
